(19) United States
(12) Patent Application Publication
(10) Pub. No.: US 2025/0140129 A1
(43) Pub. Date: May 1, 2025

(54) MODEL FOR TRAINING HIGH SIMULATION COLONOSCOPY

(71) Applicants: The First Affiliated Hospital of Naval Medical University, Shanghai (CN); Preclinic Medtech (Shanghai) Co., Ltd., Shanghai (CN)

(72) Inventors: Shengbing Zhao, Shanghai (CN); Chenglong Wang, Xiamen City (CN); Yu Bai, Shanghai (CN); Xiangyu Sui, Shandong Province (CN); Song Zhang, Shanghai (CN); Changhao Peng, Shanghai (CN); Wanzhong Wu, Fujian Province (CN)

(73) Assignees: The First Affiliated Hospital of Naval Medical University, Shanghai (CN); Preclinic Medtech (Shanghai) Co., Ltd., Shanghai (CN)

(21) Appl. No.: 18/498,409

(22) Filed: Oct. 31, 2023

(51) Int. Cl. G09B 23/28

(52) U.S. Cl. CPC G09B 23/286

(57) ABSTRACT

The present application relates to a model for training a high-simulation colonoscopy, and relates to the field of a medical training model. The model includes a colon model and a polypus model detachably mounted on the colon model. The colon model is opened and provided with polypus replacing points for mounting the polypus model. The polypus replacing points are provided on different intestinal segments of the colon model. The polypus replacing points are provided at a plurality of different positions in a circumferential direction of the colon model. This application has the effect of simulating a variety of polypus lesion training scenarios, which contributes to the efficient conduct of colonoscopy training.

### TECHNICAL FIELD

The present application relates to the field of a medical training model, and in particular, to a model for training a high-simulation colonoscopy.

### BACKGROUND

Colonoscopy is one of the most widely used and effective means of polypus screening today. Through the colonoscopy, the mucosal status of an anal canal, a rectum, a sigmoid colon, a descending colon, a transverse colon, an ascending colon, an ileum, and an ileocecal end can be viewed clearly in a sequential manner. An instrument used (a colonoscope) is a longer electronic enteroscope. Through an electronic camera mounted on the front of the enteroscope, images of a colonic mucosa are transmitted to an electronic computer for processing and finally displayed on a monitor screen, through which a doctor can observe a change in the colonic mucosa, for example, whether there is a polypus or a tumour. It is also possible to feed biopsy forceps or a looper through an instrument channel of the colonoscope to forcep or loop a polypus tissue. Finally, the polypus tissue is subjected to a pathological section for further examination.

Currently, there are three main approaches for examination and training of the colonoscopy: 1. a clinical patient, i.e., colonoscope is used in a real patient for hands-on training; 2. A silica gel simulated colon model, that is, a simulated colon model made of soft silica gel; 3. a pig intestinal model, that is, a pig intestine is separated to obtain a complete pig intestine organ which can be simulated for training.

1. The use of the clinical patient for training is prone to surgical complications caused by unskillfulness, resulting in medical disputes, while it is not always possible to find a target patient as a case for training in a determined period of time, which makes it impossible to plan the training in advance and affects the efficiency of learning; 2. The main problem of the silica gel simulated colon model is that the simulation of a current silica gel model is not high, especially for the simulation of a polypus lesion. The current silica gel model can not simulate the different types of polypus in various parts of the body. Therefore, it is difficult to carry out the operations such as polypus inspection, identification, treatment, replacement and measurement; 3. The advantage of the pig intestinal model is that the structure of a pig intestine is very similar to that of humans. But, the disadvantage of the pig intestinal model is that this pig intestinal block does not have a targeted lesion, resulting in less effective training. The three training tools of the colonoscope currently used suffer mainly from low effectiveness and low simulation.

With respect to the relevant technology involved above, an existing colon model on a market can only be used for training the retraction of the colonoscope, which is suitable for the introductory operation of colonoscopy training, but can hardly meet the requirements for the inspection, identification, treatment, replacement and measurement of a colon polypus. The existing colon model is unable to perform operations such as examination, identification, treatment, replacement and measurement of the polypus in all parts of a colon.

The inventor mainly focused on the demand for surgical skill operation training for colonoscopic polypus examination, differential diagnosis, and treatment, and specially designed and produced an operation model for colonoscopic examination surgery training.

### SUMMARY

To provide a training device that can be designed and produced with a high degree of simulation and can be repeatedly trained for the surgical training requirements of different types of colonic polypus lesions in a plurality of locations, the present application provides a model for training a high-simulation colonoscopy with a replaceable polypus module, capable of repetitively simulating different polypus lesions in different locations of the colon model, and capable of simulating a wide range of lesion training scenarios, which contributes to the efficient operation of colonoscopy training.

The present application provides a model for training a high-simulation colonoscopy using the following technical solution:

A model for training a high-simulation colonoscopy includes a colon model and a polypus model detachably mounted on the colon model. The colon model is opened and provided with polypus replacing points for mounting the polypus model. The polypus replacing points are provided on different intestinal segments of the colon model. The polypus replacing points are provided at a plurality of different positions in a circumferential direction of the colon model.

Through the use of the above technical solution, the actual operation of different polypus lesions in an intestinal tract can be simulated by replacing different polypus models mounted in the colon model. In addition, the polypus model is mounted at different intestinal segments and different circumferential position of the polypus replacing point, can simulate different types of colonic polypus lesion scenarios at a plurality of sites, and also can be repeatedly replaced and repeat the operation of the polypus model, which can meet requirements of the inspection, identification, treatment, replacement, measurement and other operation of a polypus at various parts of a colon. The model has a high simulation degree, and is more in line with the training needs of the operation of the surgical skills of the colonoscopic polypus inspection, differential diagnosis, and treatment. Before performing colonoscopic polypus examination, a lubricant can be added to the colon model through each polypus replacing point. Due to the different locations of the polypus replacing points, the lubricant can be added to the colon model at different angles and locations, which helps lubricate the inside of the colon model adequately and facilitates the access to the colonoscope during a training process.

Optionally, the colon model includes a cecum segment, an ascending colon segment, a transverse colon segment, a descending colon segment, a sigmoid colon segment, and a rectal segment. The cecum segment, the ascending colon segment, the transverse colon segment, the descending colon segment, the sigmoid colon segment and the rectal segment are each provided with one polypus replacing point.

By adopting the above technical solution, one polypus replacing point is provided in each intestinal segment, which simplifies model complexity and improves the simulation degree of the model in a case of satisfying the simulation of multi-site lesions.

Optionally, a circumferential position of each of the polypus replacing points on each of the cecum segment, the ascending colon segment, the transverse colon segment, the descending colon segment, the sigmoid colon segment, and the rectal segment is not overlapped.

By adopting the above technical solutions, the diversity of circumferential locations of polypus lesions is further supplemented to improve the simulation degree of the model and to enrich the lesion scenarios that can be simulated by the model.

Optionally, the polypus model is made of a soft elastic material. The polypus replacing point includes a mounting hole provided on an outer surface of the colon model and an insertion hole provided on an inner surface of the colon model. The mounting hole is communicated with the insertion hole. The polypus model includes a base part, a polypus part, and a connecting part for connecting the base part to the polypus part. The base part is inserted and cooperates with the mounting hole. The connecting part is dimensionally adapted to the insertion hole.

Through the use of the above technical solutions, the polypus model is inserted, connected and mounted at the polypus point. Through the insertion and cooperation, simple and convenient removable connection and fixation are achieved. The polypus part is the polypus of the simulated lesion. The polypus part passes through the surface of the inner wall of the insertion hole at the colon model to form the lesion tissue. Because the colon model itself is made of an elastic material, the connecting part is adapted to the size of the insertion hole, which can eliminate the splicing traces of the connecting part and the inner wall of the colon to a large extent, and improve the simulation degree.

Optionally, the polypus model includes an oversized polypus model, a large polypus model, a medium polypus model, and a small polypus model. The polypus part 211 of the oversized polypus model has a size greater than 20 mm. The large polypus model has a polypus size greater than 10 mm and smaller than or equal to 20 mm. The medium polypus model has a polypus size greater than 5 mm and less than or equal to 10 mm. The small polypus model has a polypus size less than or equal to 5 mm. The base parts and the connecting parts of the large polypus model, the medium polypus model, and the small polypus model are of different and decreasing sizes. The base parts and the connecting parts of the oversized polypus model and the large polypus model are of the same dimensions. The dimensions of the polypus replacing points are provided by corresponding to the mounted polypus model.

By adopting the above technical solution, clinical experience is summarized and analyzed. The polypus of common sizes is classified. Different sizes of the base parts are provided for different sizes of polypus. The sizes of the base part and the connecting part can be more adapted to the size of the polypus, so that the polypus model is joined with the colon model more closely, which improves the simulation degree.

Optionally, the polypus replacing points on the rectal segment and the transverse colon segment are of a specification greater than 10 mm. The polypus replacing points on the ascending colon segment and the sigmoid colon segment are of a specification of 5 mm-10 mm. The polypus replacing points on the cecum segment and the polypus replacing points on the descending colon segment are of a specification less than 5 mm.

Through the use of the above technical solution, different specifications of the polypus replacing points are evenly distributed in the left half of the colon and the right half of the colon of the colon model, can more fully simulate different lesion scenarios. Through the summarization of the clinical experience, common specifications of the polypus replacing points can be provided in different intestinal segments so that the actual operation of the training effect is better.

Optionally, the circumferential position of the polypus replacing point of each of the intestinal segments is projected on a cross-section of one colon model. A central angle formed by the two adjacent polypus replacing points and a center of a circle of the cross-section is 45 degrees-90 degrees.

By using the above technical solution, a balanced distribution of the polypus replacing points in the circumferential direction is guaranteed with a limited number of the polypus replacing points. In practice, the polypus lesion may appear at any position in the circumferential direction of the colon. In the present application, a central angle between the polypus replacing points is set, which can simulate obviously different positions of polypus lesions under a limited number of the polypus replacing points and optimize the training function.

Optionally, the model for training the high-simulation colonoscope further includes a decorative snap ring inserted and sleeved in an exposed end of the polypus model. The decorative snap rings all have the same external contour. A plurality of sizes of slots at the inner side of the decorative snap ring are provided according to the corresponding polypus model and the polypus replacing points.

By adopting the above technical solution, the decorative snap ring is mounted so that the appearance at the polypus replacing points of the mounted polypus model is identical, so as to avoid a difference in appearance from affecting an operator's objective determination of the size and type of the polypus, which optimizes the training attributes of the training model.

Optionally, the polypus model is divided into a regular polypus type and an irregular polypus type according to whether a shape of the polypus part is regular or not. According to Paris typing, the polypus morphology of the irregular polypus type is typed as 0-Ip (a pedunculated type). The polypus morphology of the regular polypus type is typed as 0-Isp (a sub-pedunculated type), 0-Is (a non-pedunculated type), 0-IIa (a superficially elevated type) and 0-IIb (a superficially flat type).

By using the above technical solution, the polypus type is improved. A lesion scenario that can be simulated by the colon model is enriched. The morphologic typing of the polypus adopts the five types of Paris typing: 0-Ip (the pedunculated type), 0-Isp (the sub-pedunculated type), 0-Is (the non-pedunculated type), 0-IIa (the superficially elevated type), and 0-IIb (the superficially flat type). In order to enrich the types of the polypus lesion and not to complicate the morphologic typing of the polypus so that a beginner of the colonoscopy grasps a more comprehensive range of the polypus lesion in a shorter time, according to clinical experience, the irregular polypus types are all presented as 0-Ip (the pedunculated type), and the regular polypus types are presented as four types of 0-Isp (the sub-pedunculated type), 0-Is (the non-pedunculated type), 0-IIa (the superficially elevated type), and 0-IIb (the superficially flat type).

Optionally, the irregular polypus type and the four types of the regular polypus type are correspondingly provided with four different size specifications of the polypus models of the oversized polypus model, the large polypus model, the medium polypus model and the small polypus model. 0-IIb (the superficially flat type) class of the regular polypus type is additionally provided with the large polypus model, the medium polypus model and the small polypus model and three different size specifications of the polypus models.

By adopting the above technical solution, the plurality of polypus models are provided for each type of polypus lesion, which can enrich the simulated types of polypus lesions. 0-IIb (the superficially flat type) class of the polypus is more difficult to be recognized as the polypus lesion from appearance. Therefore, so 0-IIb (the superficially flat type) class of the polypus can be used as a blocking piece in addition to the discernment of the polypus lesion. A set of the 0-IIb (the superficially flat type) class of the regular polypus of the large polypus model, the medium polypus model, and the small polypus model is additionally provided, which can block all of the six polypus replacing points as a commonly used simulation scenario without the polypus lesion.

In summary, the present application includes the following beneficial technical effects:

1. The present application discloses a model for training a high-simulation colonoscopy. A detachable polypus model is mounted on a colon model, so that an operator may flexibly configure a desired type of polypus model according to needs. In addition, a polypus model may be mounted in different positions in a length direction and a circumferential direction of the colon model to simulate the variety of polypus lesion positions and improve an overall simulation degree of the training model. Polypus replacing points are provided, which also helps lubricate the inner part of the colon model.

2. The six polypus replacing points are provided and distributed over each intestinal segment, which simplifies the model while being able to enrich a simulated lesion scenario;

3. The polypus models are categorized according to polypus sizes of 5 mm, 10 mm, and 20 mm. Therefore, on the one hand, more adapted sizes of the polypus replacing points and the base part are correspondingly provided, which helps improve the simulation degree of the model. On the other hand, polypus sizes are categorized according to domestic and foreign topical journal reports and clinical experience, which facilitates the flexible configuration of the polypus model according to the needs of training.

### BRIEF DESCRIPTION OF DRAWINGS

FIG. 1 is a schematic diagram of an overall structure of a colon model in an embodiment of the present application;

FIG. 2 is a schematic structural diagram I of polypus replacing points in an embodiment of the present application;

FIG. 3 is a schematic structural diagram II of polypus replacing points in an embodiment of the present application;

FIG. 4 is a schematic diagram of circumferential distribution of polypus replacing points in embodiments of the present application;

FIG. 5 is a schematic diagram of an overall structure of an embodiment of the present application.

In the figures: 1, colon model; 11, polypus replacing point; 111, mounting hole; 112, insertion sleeving part; 113, insertion hole; 12, cecum segment; 13, ascending colon segment; 14, transverse colon segment; 15, descending colon segment; 16, sigmoid colon segment; 17, rectal segment; 18, epityphlon segment; 19, anal segment; 2, polypus model; 21, replacing part; 211, polypus part; 212, connecting part; 213, pedunculated part; 22, base part; 221, post body; 222, cover plate; 223, flange; 224, T-shaped connecting head; 3, simulated sphincter; 4, decorative snap ring; 5, housing; 51, transparent viewing window; 52, fixing snap ring.

### DETAILED DESCRIPTION OF EMBODIMENTS

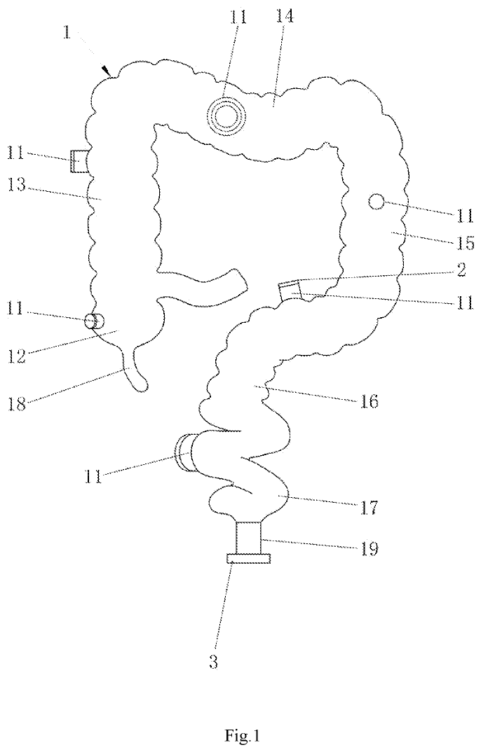

The present application is described in further detail below in conjunction with FIGS. 1-5.

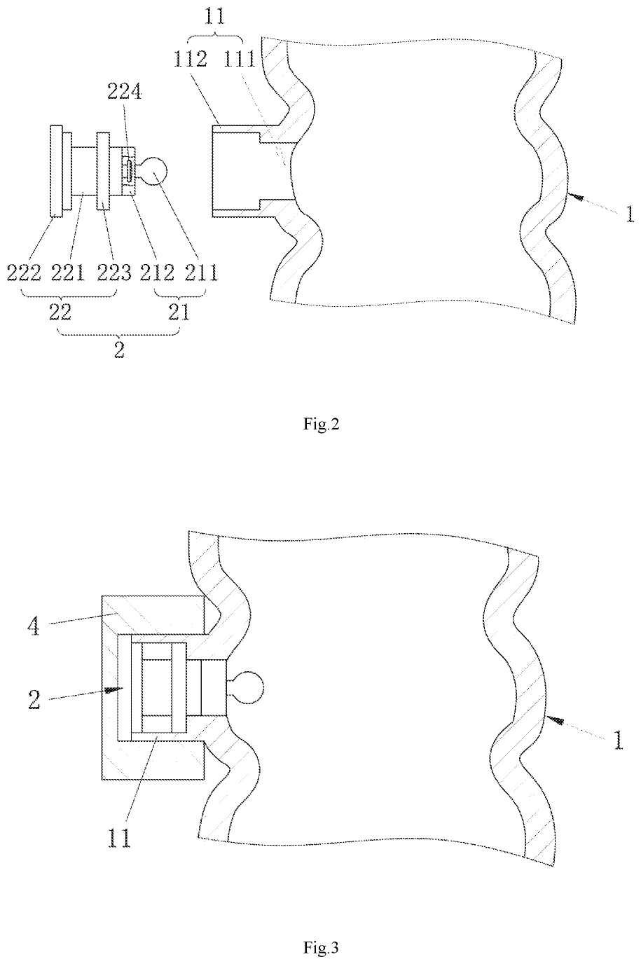

Referring to FIGS. 1 and 2, an embodiment of the present application discloses a model for training a high-simulation colonoscopy, including a colon model 1 and a polypus model 2. The polypus model 2 is detachably mounted on the colon model 1.

The colon model 1 is made of a soft, crease-formable material, such as high-performance silica gel. The colon model 1 includes an epityphlon segment 18, a cecum segment 12, an ascending colon segment 13, a transverse colon segment 14, a descending colon segment 15, a sigmoid colon segment 16, a rectal segment 17, and an anal segment 19, which are provided in sequence. Polypus replacing points 11 are provided on the cecum segment 12, the ascending colon segment 13, the transverse colon segment 14, the descending colon segment 15, the sigmoid colon segment 16, and the rectal segment 17.

A simulated sphincter 3 is mounted at the anal segment 19. The simulated sphincter 3 is a circular inflatable airbag sleeved and mounted on the anal segment 19, which simulates the contraction force of the simulated sphincter 3 through the pneumatic elasticity of the airbag to improve the simulation degree of the model.

Referring to FIGS. 2 and 3, the colon model 1 is provided thereon with the plurality of polypus replacing points 11 for removably mounting the polypus model 2. The polypus replacing points 11 include a mounting hole 111 provided on the outer surface of the colon model 1 and an insertion hole 113 provided on the inner surface of the colon model 1. The mounting holes 111 is communicated with the insertion hole 113. An insertion sleeving part 112 extends outwardly and is provided on the outer surface of the colon model 1 corresponding to the contour of the mounting hole 111. The polypus model 2 includes a base part 22, a polypus part 211, and a connecting part 212 connecting the base part 22 to the polypus part 211. A cylindrical pedunculated part 213 is also provided between the connecting part 212 and the polypus part 211 when the polypus morphology of the polypus model has 0-Ip (a pedunculated type) or 0-Isp (a sub-pedunculated type). The connecting part 212, the pedunculated part 213, and the polypus part 211 are integrally molded. However, the connecting part 212 and the pedunculated part 213 are made of the same high-performance silica gel material (R2-0050) as that of the colon model 1. The polypus part 211, as a lesion tissue, is made of a relatively darker-colored high-performance silica gel material (R4-0030). The two silica gel materials are integrally molded by two-color injection molding.

The base part 22 is inserted and cooperates with the mounting hole 111. The pedunculated part 213 is dimensionally adapted to the insertion hole 113. The base part 22 is made of plastic. The connecting part 212 is detachably mounted on the base part.

The base part 22 includes a cover plate 222 that resists against the end surface of the insertion sleeving part 112, a flange 223 that is blocked and connected to the inner wall of the insertion sleeving part 112, and a post body 221 that connects the cover plate 222 to the flange 223. The cover plate 222, the flange 223, and the post body 221 are integrally provided. The base part 22 is inserted and fixed in the insertion sleeving part 112 at the polypus replacing points 11. The entire polypus model 2 is disassembled and assembled by insertion and removal manners.

A T-shaped connecting head 224 is provided at one end of the post body 221 near the replacing part 21. a T-shaped slot is correspondingly provided on the connecting part 212 corresponding to the T-shaped connecting head 224. The polypus part 211, the pedunculated part 213, and the connecting part 212 form the replacing part 21 detachably mounted on the base part 22.

Referring to FIG. 1, the polypus model 2 includes an oversized polypus model, a large polypus model, a medium polypus model, and a small polypus model. The polypus part 211 of the oversized polypus model has a size greater than 20 mm. The large polypus model has a polypus size greater than 10 mm and smaller than or equal to 20 mm. The medium polypus model has a polypus size greater than 5 mm and less than or equal to 10 mm. The small polypus model has a polypus size less than or equal to 5 mm. The base parts 22 and the connecting parts 212 of the large polypus model, the medium polypus model, and the small polypus model are of different and decreasing sizes. The base parts 22 and the connecting parts 212 of the oversized polypus model and the large polypus model are of the same dimensions. The dimensions of the polypus replacing points 11 are provided by corresponding to the mounted polypus model 2.

Referring to FIG. 1, the polypus replacing points 11 on the rectal segment 17 and the transverse colon segment 14 are of a specification greater than 10 mm. The polypus replacing points 11 on the ascending colon segment 13 and the sigmoid colon segment 16 are of a specification 11 of 5 mm-10 mm. The polypus replacing points on the cecum segment 12 and the polypus replacing points on the descending colon segment 15 are of a specification less than 5 mm.

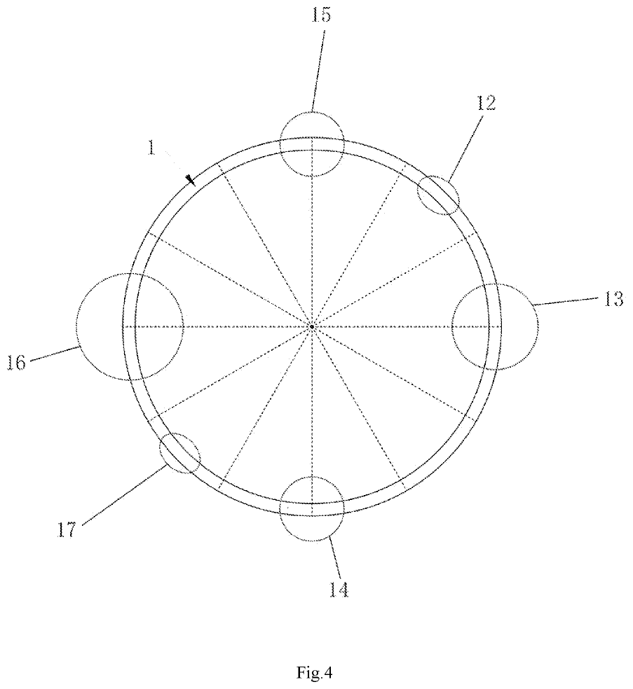

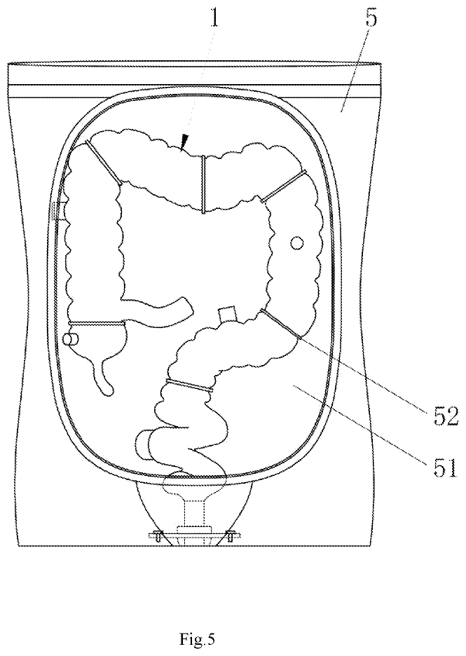

Referring to FIG. 4, the circumferential position of the polypus replacing point 11 on each of intestinal segments is projected onto a circular cross-section of the colon model. A central angle formed by the two adjacent polypus replacing points 11 and a center of a circle of a cross-section is 45 degrees to 90 degrees. In this embodiment, the circumferential distribution of the polypus replacing points 11 of each of the intestinal segments in the circumferential upward direction of the colon model 1 with reference to a clock is as follows: the polypus replacing point 11 of the cecum segment 12 is located in the middle of a 1 to 2 o'clock azimuth; the polypus replacing point 11 of the ascending colon segment 13 is located in a 3 o'clock azimuth; the polypus replacing point 11 of the transverse colon segment 14 is located in a 6 o'clock azimuth; the polypus replacing point 11 of the rectal segment 17 is located in the middle of a 7 to 8 o'clock azimuth; the polypus replacing point 11 of the sigmoid colon segment 16 is located in a 9 o'clock azimuth, and the polypus replacing point 11 of the descending colon segment 15 is located in a 12 o'clock azimuth. The polypus replacing points on the cecum segment 12, the ascending colon segment 13, the transverse colon segment 14, the descending colon segment 15, the sigmoid colon segment 16, and the rectal segment 17 are distributed in a centro-symmetric manner.

Referring to FIGS. 2 and 3, the model for training the high-simulation colonoscope also includes a decorative snap ring 4. the plurality of decorative snap rings 4 are provided at the corresponding polypus replacing points 11. The decorative snap rings 4 all have the same outer contour. The decorative snap ring 4 is inserted, sleeved and mounted on the insertion sleeving part 112 of the corresponding polypus replacing points 11, so that the appearance of the plurality of polypus replacing points 11 is identical. A plurality of sizes of slots at the inner side of the decorative snap ring 4 are provided according to the insertion sleeving part 112 of the corresponding polypus replacing point 11.

The polypus model 2 is divided into a regular polypus type and an irregular polypus type according to whether the shape of the polypus part 211 is regular or not. Polypus morphology typing uses the five categories of the Paris typology: 0-Ip (the pedunculated type), 0-Isp (the sub-pedunculated type), 0-Is (a non-pedunculated type), 0-IIa (a superficially elevated type), and 0-IIb (a superficially flat type). polypus morphology typing for the irregular polypus type is all 0-Ip (the pedunculated type). Polypus morphology typing for the regular polypus type includes 0-Isp (the sub-pedunculated type), 0-Is (the non-pedunculated type), 0-IIa (the superficially elevated type), and 0-IIb (the superficially flat type). The irregular polypus type and the four types of the regular polypus type are correspondingly provided with four different size specifications of the polypus models of the oversized polypus model, the large polypus model, the medium polypus model, and the small polypus model. 0-IIb (the superficial flat type) class of the regular polypus type is additionally provided with the large polypus model, the medium polypus model, and the small polypus model and three different size specifications of the polypus models. 0-IIb (the superficially flat type) class of regular polypus are of different sizes and are difficult to be identified as a polypus lesion from appearance thereof, thus enriching the size and type of a polypus and serving as a commonly used simulation scenario for the absence of the polypus lesion. See the table below for details.

| Polypus | | Size | | Corresponding |
|---|---|---|---|---|
| number | Size (mm) | classification | Paris typing | intestinal segment |
| 1 | 2.4 | ≤5 | 0-IIa | Cecum and |
| | | | | descending colon |
| 2 | 3.1 | ≤5 | 0-Is | Cecum and |
| | | | | descending colon |
| 3 | 4.2 | ≤5 | 0-Isp | Cecum and |
| | | | | descending colon |
| 4 | 4.6 | ≤5 | 0- | Cecum and |
| | | | Ip (irregular) | descending colon |
| 5 | 6.1 | 5-10 | 0-IIa | Ascending colon |
| | | | | and sigmoid colon |
| 6 | 7.3 | 5-10 | 0-Is | Ascending colon |
| | | | | and sigmoid colon |
| 7 | 8.7 | 5-10 | 0-Isp | Ascending colon |
| | | | | and sigmoid colon |
| 8 | 9.5 | 5-10 | 0- | Ascending colon |
| | | | Ip (irregular) | and sigmoid colon |
| 9 | 12.8 | 10-20 | 0-IIa | Rectal colon and |
| | | | | transverse colon |
| 10 | 14.5 | 10-20 | 0-Is | Rectal colon and |
| | | | | transverse colon |
| 11 | 18.2 | 10-20 | 0-Isp | Rectal colon and |
| | | | | transverse colon |
| 12 | 19.3 | 10-20 | 0- | Rectal colon and |
| | | | Ip (irregular) | transverse colon |
| 13 | 4.9 | ≤5 | 0-IIb | Cecum and |
| | | | | descending colon |
| 14 | 4.4 | ≤5 | 0-IIb | Cecum and |
| | | | | descending colon |
| 15 | 9.8 | 5-10 | 0-IIb | Ascending colon |
| | | | | and sigmoid colon |
| 16 | 9.3 | 5-10 | 0-IIb | Ascending colon |
| | | | | and sigmoid colon |
| 17 | 19.4 | 10-20 | 0-IIb | Rectal colon and |
| | | | | transverse colon |
| 18 | 19.9 | 10-20 | 0-IIb | Rectal colon and |
| | | | | transverse colon |
| 19 | 20.5 | >20 | 0-IIa | Rectal colon and |
| | | | | transverse colon |
| 20 | 20.8 | >20 | 0-Is | Rectal colon and |
| | | | | transverse colon |
| 21 | 21.3 | >20 | 0-Isp | Rectal colon and |
| | | | | transverse colon |
| 22 | 21.6 | >20 | 0- | Rectal colon and |
| | | | Ip (irregular) | transverse colon |

Referring to FIG. 5, the model for training the high-simulation colonoscope also includes a housing 5 and a fixing snap ring 52. The housing 5 is a cavity structure imitating a human body. The colon model 1 is mounted inside the housing 5. The colon model 1 is fixed with a connecting plate at an anus position. An anus passes through the side wall of the housing 5 and is fixed in position by the connecting plate. The connecting plate is detachably mounted to the housing 5 via an adhesive tape. The fixing snap ring 52 is detachably fixed in the housing 5 with a spring ring and the adhesive tape. The fixing snap ring 52 is a clamp member spanning the colon model 1. The plurality of fixing snap rings 52 are provided along a lengthwise direction of the colon model 1 to shape the overall contour of the colon model 1. The housing 5 is provided thereon with a transparent viewing window 51. The transparent viewing window 51 is made of plastic. The transparent viewing window 51 is detachably fixed to the housing 5 via a snap structure. When it is necessary to replace and maintain the colon model 1, the transparent viewing window 51 is taken down to dismantle the colon model 1.

An embodiment of the present application discloses the implementation principle of a model for training a high-simulation colonoscopy as follows: polypus replacing points 11 are provided on a colon model 1. A polypus model 2 is mounted detachably on the polypus replacing point 11, so as to simulate different types of colon polypus lesions in the colon model 1. The polypus replacing points 11 are provided on different intestinal segments of the colon model 1 so as to simulate different types of colon polypus lesions for a plurality of parts, and further improve a simulation degree. The polypus model 2 may be replaced by plugging and unplugging, which meets the demand for the repetitive use of the training model.

The above are preferable embodiments of the present application, and are not intended to limit the scope of protection of the present application. Therefore, any equivalent changes made in accordance with a structure, a shape, and principles of the present application shall be covered by the scope of protection of the present application.

What is claimed is:

1. A model for training a high-simulation colonoscopy, comprising a colon model (1) and a polypus model (2) detachably mounted on the colon model (1); the colon model (1) is opened and provided with polypus replacing points (11) for mounting the polypus model (2), the polypus replacing points (11) are provided on different intestinal segments of the colon model (1); and the polypus replacing points (11) are provided at a plurality of different positions in a circumferential direction of the colon model (1).

2. The model for training a high-simulation colonoscopy according to claim 1, wherein the colon model (1) comprises a cecum segment (12), an ascending colon segment (13), a transverse colon segment (14), a descending colon segment (15), a sigmoid colon segment (16), and a rectal segment (17); and the cecum segment (12), the ascending colon segment (13), the transverse colon segment (14), the descending colon segment (15), the sigmoid colon segment (16) and the rectal segment (17) are each provided with one polypus replacing point (11).

3. The model for training a high-simulation colonoscopy according to claim 2, wherein a circumferential position of each of the polypus replacing points (11) on each of the cecum segment (12), the ascending colon segment (13), the transverse colon segment (14), the descending colon segment (15), the sigmoid colon segment (16), and the rectal segment (17) is not overlapped.

4. The model for training a high-simulation colonoscopy according to claim 3, wherein the polypus model (2) is made of a soft elastic material; the polypus replacing point (11) comprises a mounting hole (111) provided on an outer surface of the colon model (1) and an insertion hole (113) provided on an inner surface of the colon model (1), and the mounting hole (111) is communicated with the insertion hole (113); the polypus model (2) comprises a base part (22), a polypus part (211), and a connecting part (212) for connecting the base part (22) to the polypus part (211), the base part (22) is inserted and cooperates with the mounting hole (111), and the connecting part (212) is dimensionally adapted to the insertion hole (113).

5. The model for training a high-simulation colonoscopy according to claim 4, wherein the polypus model (2) comprises an oversized polypus model, a large polypus model, a medium polypus model, and a small polypus model, the polypus part 211 of the oversized polypus model has a size greater than 20 mm, the large polypus model has a polypus size greater than 10 mm and smaller than or equal to 20 mm, the medium polypus model has a polypus size greater than 5 mm and less than or equal to 10 mm, the small polypus model has a polypus size less than or equal to 5 mm; the base parts (22) and the connecting parts (212) of the large polypus model, the medium polypus model, and the small polypus model are of different and decreasing sizes; the base parts (22) and the connecting parts (212) of the oversized polypus model and the large polypus model are of the same dimensions; and the dimensions of the polypus replacing points (11) are provided by corresponding to the mounted polypus model (2).

6. The model for training a high-simulation colonoscopy according to claim 5, wherein the polypus replacing points (11) on the rectal segment (17) and the transverse colon segment (14) are of a specification greater than 10 mm, the polypus replacing points (11) on the ascending colon segment (13) and the sigmoid colon segment (16) are of a specification of 5 mm-10 mm, and the polypus replacing points (11) on the cecum segment (12) and the polypus replacing points (11) on the descending colon segment (15) are of a specification less than 5 mm.

7. The model for training a high-simulation colonoscopy according to claim 6, wherein the circumferential positions of the polypus replacing points (11) of each of the intestinal segments is projected on a cross-section of one colon model (1), and a central angle formed by the two adjacent polypus replacing points (11) and a center of a circle of the cross-section is 45 degrees-90 degrees.

8. The model for training a high-simulation colonoscopy according to claim 1, further comprising a decorative snap ring (4) inserted and sleeved in an exposed end of the polypus model (2), the decorative snap rings (4) all having the same external contour, and a plurality of sizes of slots at the inner side of the decorative snap ring (4) being provided according to the corresponding polypus model (2) and the polypus replacing points (11).

9. The model for training a high-simulation colonoscopy according to claim 5, wherein the polypus model (2) is divided into a regular polypus type and an irregular polypus type according to whether a shape of the polypus part (211) is regular or not; and according to Paris typing, a polypus morphology of the irregular polypus type is typed as 0-Ip (a pedunculated type), and a polypus morphology of the regular polypus type is typed as 0-Isp (a sub-pedunculated type), 0-Is (a non-pedunculated type), 0-IIa (a superficially elevated type) and 0-IIb (a superficially flat type).

10. The model for training a high-simulation colonoscopy according to claim 9, wherein the irregular polypus type and four types of the regular polypus type are correspondingly provided with four different size specifications of the polypus models (2) of the oversized polypus model, the large polypus model, the medium polypus model and the small polypus model; 0-IIb (the superficially flat type) class of the regular polypus type is additionally provided with the large polypus model, the medium polypus model and the small polypus model and three different size specifications of the polypus models (2).
